(19) United States
(12) Patent Application Publication
(10) Pub. No.: US 2025/0379804 A1
(43) Pub. Date: Dec. 11, 2025

(54) Dynamic and Adaptive Observability System

(71) Applicant: TELEFONAKTIEBOLAGET LM ERICSSON (PUBL), Stockholm (SE)

(72) Inventors: Timo Simanainen, VEIKKOLA (FI); Tero Kauppinen, ESPOO (FI)

(21) Appl. No.: 18/875,001

(22) PCT Filed: Jun. 22, 2022
(86) PCT No.: PCT/IB2022/055809

§ 371 Date: Dec. 13, 2024

(51) Int. Cl. H04L 43/024; H04L 41/16; H04L 43/103; H04L 43/12

(52) U.S. Cl. CPC H04L 43/024; H04L 41/16; H04L 43/103; H04L 43/12

(57) ABSTRACT

A method performed by a controller computing node to dynamically adjust a detail level of observation data collected by an observability system. The method includes receiving observation data collected by a plurality of agent computing nodes, determining, based on analyzing the observation data collected by the plurality of agent computing nodes, that a detail level of observation data collected by one or more of the plurality of agent computing nodes is to be changed, and responsive to determining that the detail level of observation data collected by the one or more agent computing nodes is to be changed, instructing the one or more agent computing nodes to change the detail level of observation data that they collect.

### TECHNICAL FIELD

Embodiments disclosed herein relate to the field of observability systems, and more specifically, to dynamically adjusting the detail level of observation data collected by an observability system.

### BACKGROUND

As systems become larger, more complex, and geographically distributed, the observability of systems becomes more important. Observability is a measure of how well the internal states of the system can be inferred from knowledge of its external outputs. Maintenance of a large and geographically distributed system with a large number of nodes is difficult without using an observability system.

Currently there exists several tools that can be used for observing a running system including Prometheus®, Zipkin®, and Jaeger®. Prometheus® is an open-source systems monitoring and alerting tool that can be used for visualizing and reporting the performance of a system. Zipkin® is a distributed tracing tool that can be used for troubleshooting latency problems in a system. Jaeger® is a distributed tracing tool that can be used for measuring the performance of a system and obtaining logging information from multiple nodes or clusters.

OpenTelemetry® and OpenTraceApi® define a common way for sending and receiving observability-related data. OpenTelemetry® can be used, for example, with Prometheus®, Zipkin®, Jaeger®, and other tools/applications.

Existing observability systems are static after instantiation and communication is unidirectional. That is, the observation data collectors collect a predefined set of information and provide the collected data to a central location for analysis.

Observability typically involves a trade-off between system performance and the amount of data collected. In general, when more data is collected, more central processing unit (CPU) and network resources are consumed, and thus the performance of the system being observed suffers. Typically, it is desirable to keep this performance penalty as small as possible, and thus the amount of data collected is restricted. This restriction decreases the usefulness of the collected data and the observability system.

### SUMMARY

A method performed by a controller computing node is disclosed to dynamically change a detail level of observation data collected by an observability system. The method includes receiving observation data collected by a plurality of agent computing nodes, determining, based on analyzing the observation data collected by the plurality of agent computing nodes, that a detail level of observation data collected by one or more of the plurality of agent computing nodes is to be changed, and responsive to determining that the detail level of observation data collected by the one or more agent computing nodes is to be changed, instructing the one or more agent computing nodes to change the detail level of observation data that they collect.

A non-transitory machine-readable storage medium is disclosed that provides instructions that, if executed by a processor of a computing device implementing a controller computing node, will cause the controller computing node to perform operations for dynamically changing a detail level of observation data collected by an observability system. The operations include receiving observation data collected by a plurality of agent computing nodes, determining, based on analyzing the observation data collected by the plurality of agent computing nodes, that a detail level of observation data collected by one or more of the plurality of agent computing nodes is to be changed, and responsive to determining that the detail level of observation data collected by the one or more agent computing nodes is to be changed, instructing the one or more agent computing nodes to change the detail level of observation data that they collect.

A method performed by an agent computing node is disclosed to change a detail level of observation data collected by the agent computing node. The method includes collecting first observation data in accordance with a first observation data collection setting that corresponds to a first detail level, receiving, from a controller computing node, an instruction to change the detail level of observation data collected by the agent computing node, responsive to receiving the instruction to change the detail level of observation data collected by the agent computing node, changing an observation data collection setting of the agent computing node from the first observation data collection setting to a second observation data collecting setting that corresponds to a second detail level that is different from the first detail level, and collecting second observation data in accordance with the second observation data collection setting.

A non-transitory machine-readable storage medium is disclosed that provides instructions that, if executed by a processor of a computing device implementing an agent computing node, will cause the agent computing node to perform operations for changing a detail level of observation data collected by the agent computing node. The operations include collecting first observation data in accordance with a first observation data collection setting that corresponds to a first detail level, receiving, from a controller computing node, an instruction to change the detail level of observation data collected by the agent computing node, responsive to receiving the instruction to change the detail level of observation data collected by the agent computing node, changing an observation data collection setting of the agent computing node from the first observation data collection setting to a second observation data collecting setting that corresponds to a second detail level that is different from the first detail level, and collecting second observation data in accordance with the second observation data collection setting.

### BRIEF DESCRIPTION OF THE DRAWINGS

The invention may best be understood by referring to the following description and accompanying drawings that are used to illustrate embodiments of the invention. In the drawings:

FIG. 1 is a diagram showing an example architecture of an observability system, according to some embodiments.

FIG. 2A is a diagram showing interactions between components to dynamically adjust the detail level of observation data collected by an observability system, according to some embodiments.

FIG. 2B is a diagram showing interactions between components to retrieve locally stored observation data and adaptively adjust the detail level of observation data collected by an observability system, according to some embodiments.

FIG. 3 is a flow diagram showing a method performed by a controller computing node for dynamically adjusting the detail level of observation data collected by an observability system, according to some embodiments.

FIG. 4 is a flow diagram showing a method performed by an agent computing node for dynamically adjusting the detail level of observation data collected by an observability system, according to some embodiments.

FIG. 5 is a flow diagram showing operations performed by an agent computing node for adaptively adjusting the detail level of observation data collected by an observability system, according to some embodiments.

FIG. 6A illustrates connectivity between network devices (NDs) within an exemplary network, as well as three exemplary implementations of the NDs, according to some embodiments of the invention.

FIG. 6B illustrates an exemplary way to implement a special-purpose network device according to some embodiments of the invention.

### DETAILED DESCRIPTION

The following description describes methods and apparatus for dynamically adjusting the detail level of observation data collected by an observability system. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

As mentioned above, observability typically involves a trade-off between system performance and the amount of data collected. Typically, it is desirable to keep the performance penalty added by the observability system as small as possible, and thus the amount of data collected is restricted. This restriction decreases the usefulness of the collected data and the observability system.

Embodiments use a dynamic and/or adaptive approach to observing a system that provides relevant information for troubleshooting the system and finding the root cause of problems occurring in the system while reducing the impact on the system being observed.

The dynamic approach to observing a system allows a controller computing node to increase the detail level of observation data collected by one or more agent computing nodes when a problem or anomaly is detected in the system being observed. For example, under normal conditions, the agent computing nodes may collect a minimal amount of observation data from the system being observed to minimize/reduce the performance penalty. However, when a problem or anomality is detected in the system being observed, the controller computing node may instruct one or more agent computing nodes that are at or near the area where the problem or anomaly was detected to increase the detail level of the observation data collected by those agent computing nodes. This helps provide more detail about the problem or anomaly (e.g., which can help with troubleshooting). However, the performance penalty is minimal since the more detailed observation data is only collected from a limited part of the system being observed (and for a limited length of time).

The dynamic approach can also be applied to the sending of collected observation data. Not all observation data collected by an agent computing node needs to be immediately sent to the controller computing node. For example, the agent computing node may decide to only send some of the observation data that it collected to the controller computing node for analysis and temporarily store the other observation data that it collected in its non-persistent storage (e.g., in random access memory (RAM)). When the controller computing node detects a problem or anomality in the system being observed, the controller computing node may send a request to the agent computing node for the observation data locally stored at the agent computing node. As the agent computing node collects new observation data, the agent computing node may overwrite/replace older observation data stored in its non-persistent storage with the new observation data to reduce the amount of storage needed. This “dash cam” style approach helps reduce network usage and memory usage but still allows collected observation data to be made available (at least temporarily) in the event that it is needed.

The adaptive approach to observing a system allows an agent computing node to adjust the detail level of observation data that it collects when a certain condition is detected without receiving explicit instructions to do so from the central observability controller. For example, if an agent computing node detects an increase in network usage, the agent computing node may temporarily increase the detail level of observation data that it collects to help with determining the relevant nodes that are participating in sending network traffic. In an embodiment, the dynamic approach is combined with the adaptive approach to start collecting more detailed observation data at the relevant nodes. In this manner, the observability system may automatically start collecting more detailed observation data from targeted parts of the system being observed for a certain length of time, when needed. Having the additional detail may help with finding the root cause of the problem or anomaly. Embodiments are further described herein with reference to the accompanying figures.

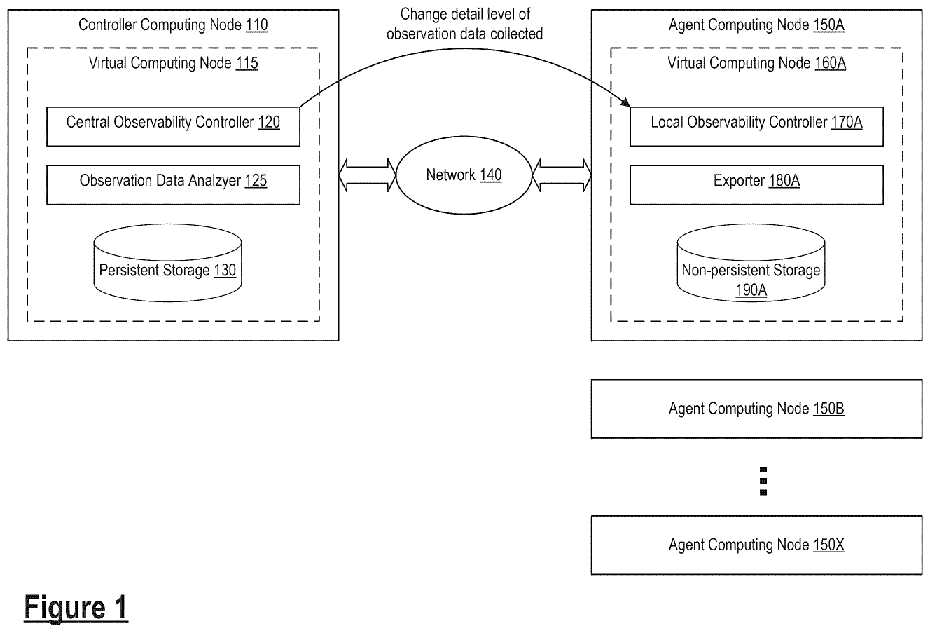

FIG. 1 is a diagram showing an example architecture of an observability system, according to some embodiments. As shown in the diagram, the observability system includes a controller computing node 110 and agent computing nodes 150A-X. The controller computing node 110 may communicate with the agent computing nodes 150A-X over a network 140. The agent computing nodes 150A-X may collectively implement a distributed system (e.g., an application composed of a number of microservices).

As shown in the diagram, the controller computing node 110 includes a central observability controller 120, an observation data analyzer 125, and a persistent storage 130. In an embodiment, one or more of these components can be virtualized. For example, the controller computing node 110 may implement a virtual computing node 115 that implements the central observability controller 120, the observation data analyzer, and/or the persistent storage 130. Also, as shown in the diagram, agent computing node 150A includes a local observability controller 170A, an exporter 180A, and a non-persistent storage 190A. In an embodiment, one or more of these components can be virtualized. For example, agent computing node 150A may implement a virtual computing node 160A that implements local observability controller 170A, exporter 180A, and/or non-persistent storage 190A. The other agent computing nodes 150 may include the same or similar components as agent computing node 150A (which are not shown in the diagram to reduce clutter) and may operate in a similar manner to agent computing node 150A.

Exporter 180A (e.g., node_exporter or opentelemetry_exporter) is executed in an execution environment of agent computing node 150A. Exporter 180A may collect observation data related to the execution environment and send the collected observation data to local observability controller 170A. The observation data may include measurement data and/or trace data. Measurement data may include numeric information such as the number of received/sent network packages per second, CPU utilization percentage, or the like. Trace data may include information regarding events that are determined to belong together. For example, trace data may include logs/information that follow a particular Hypertext Transfer Protocol (HTTP) session. For example, this information may include information regarding a connection request received event (SYN), a connection request response sent event (SYN ACK), a HTTP GET request received event, a HTTP 200 OK response sent event, and a connection closed event (RST). In an embodiment, the trace data includes copies of actual network traffic that was sent/received/processed by agent computing node 150A (e.g., packets sent/received/processed by agent computing node 150A or portions thereof). Local observability controller 170A may send observation data it received from exporter 180A to the central observability controller 120 (e.g., over the network 140 using an observability API/framework).

The central observability controller 120 is responsible for managing the local observability controllers 170 of the agent computing nodes 150. The central observability controller 120 may receive observation data collected by the agent computing nodes 150 from the respective local observability controllers 170 of those agent computing nodes 150 and store the received observation data in the persistent storage 130. In an embodiment, the persistent storage 130 is a persistent database. In an embodiment, the central observability controller 120 receives observation data from the local observability controllers 170 using an observability application programming interface (API)/framework such as OpenTelemetry. The central observability controller 120 may receive the observation data using a “push” mechanism (e.g., the local observability controllers 170 send observation data to the central observability controller 120 when the observation data is available) and/or a “pull” mechanism (e.g., the central observability controller 120 requests the observation data from the local observability controllers 170).

The observation data analyzer 125 may analyze the observation data that was received by the central observability controller 120 from the local observability controllers 170 of the agent computing nodes 150 (which may be stored in the persistent storage 130) and determine whether the detail level of observation data collected is to be changed based on the analysis. In an embodiment, the observation data analyzer 125 analyzes observation data based on applying a rule-based algorithm and/or machine learning algorithm to the observation data. If the observation data analyzer 125 determines that the detail level of observation data collected is to be changed, then it may send a request to the central observability controller 120 to change the detail level of observation data collected. Responsive to receiving the request from the observation data analyzer 125, the central observability controller 120 may determine which agent computing nodes 150 should change the detail level of observation data that they collect. The central observability controller 120 may then send instructions to the respective local observability controllers 170 of those agent computing nodes 150 to change the detail level of observation data that those agent computing nodes 150 collect. The instructions may indicate the specific observation data that is to be collected. In an embodiment, the instructions include extended Berkeley Packet Filter (eBPF) code and/or higher level instructions indicating the observation data that is to be collected. In general, collecting more detailed observation data consumes more computing resources (e.g., CPU), storage resources (e.g., memory), and/or network resources (e.g., bandwidth) compared to collecting less detailed observation data. Thus, it is desirable to only collect more detailed observation data when needed. In an embodiment, the observability system begins with collecting less detailed (generic/broad) observation data (e.g., to conserve resources) and then increases the detail level of observation data collected, as needed (e.g., when a problem or anomaly occurs in a part of the system being observed). As a non-limiting example, the observability system may initially just count the total number of dropped/failed packets (low detail level). Next, the observability system may collect data at the level individual network connections (higher detail level). Next, the agent computing node 150 may collect system tracing statistics and/or packet-level details (e.g., contents of packets) (even higher detail level). The observability system may decrease the detail level of observation data it collects after a specified length of time or after it has been determined that the collection of the more detailed observation data is no longer needed.

In some cases, it might not be necessary to change the detail level of observation data collected by all of the agent computing nodes 150 in the observability system. Thus, in an embodiment, the central observability controller 120 instructs some (but not all) of the local observability controllers 170 to change the detail level of observation data collected. In this way, the central observability controller 210 may cause more or fewer detailed observation data to be collected from targeted parts of the system being observed.

For example, if the observation data analyzer 125 determines, based on analyzing the observation data stored in the persistent storage 130, that a problem or anomaly occurred in the system being observed, the observation data analyzer 125 may send a request to the central observability controller 120 to increase the detail level of observation data collected. Responsive to receiving the request, the central observability controller 120 may determine that the problem or anomaly occurred at or near agent computing node 150A. Thus, the central observability controller 120 may send an instruction to local observability controller 170A (of agent computing node 150A) to collect more detailed observation data than before.

Local observability controller 170A may receive instructions from the central observability controller 120 to change the detail level of observation data that it collects. Responsive to receiving such an instruction from the central observability controller 120, local observability controller 170A may configure exporter 180A to change the detail level of observation data collected by exporter 180A according to the instruction. For example, local observability controller 170A may cause exporter 180A to change the exporter's 180A observation data collection setting from a first observation data collection setting to a second observation data collection setting, where the second observation data collection setting corresponds to a different detail level than that of the first observation data collection setting. Exporter 180A may then collect observation data in accordance with the instruction received from local observability controller 170A.

Thus, the central observability controller 120 may receive observation data collected by the agent computing nodes 150 and provide the observation data to the observation data analyzer 125. The observation data analyzer 125 may analyze the observation data to determine whether the detail level of observation data collected is to be changed based on the analysis. If the observation data analyzer 125 determines that the detail level of observation data collected is to be changed, then the observation data analyzer 125 may notify the central observability controller 120 and the central observability controller 120 may instruct the relevant agent computing nodes 150 to change the detail level of observation data that they collect (e.g., indefinitely until further notice or for a specified length of time). This process may be repeated to continually adjust the detail level of observation data collected in the system being observed (e.g., to collect more detailed observation data to help with troubleshooting or to collect less detailed observation data to conserve resources), as needed.

A technical advantage of certain embodiments disclosed herein over existing observability systems is that they allow for conserving computing, storage, and/or network resources under normal conditions (e.g., by collecting less detailed observation data) but at the same time allow for collecting more detailed observation data when needed (e.g., when a problem or anomaly is detected in the system being observed). Moreover, the collection of more detailed observation data can be targeted to a limited area of the system being observed and for a limited length of time, which helps further conserve resources.

In an embodiment, local observability controller 170A collects more observation data than it sends to the central observability controller 120. For example, local observability controller 170A may send some of the observation data that it collected to the central observability controller (e.g., observation data that is deemed to be associated with a problem/anomaly) but temporarily store the other collected observation data (e.g., observation data that is deemed not to be associated with a problem/anomaly (“happy path” observation data)) in non-persistent storage 190A. In an embodiment, non-persistent storage 190A is an in-memory database. In general, non-persistent storage 190A allows for faster storage/access compared to the persistent storage 130 but is more expensive (and thus typically has less storage capacity). The central observability controller 120 may send a request to local observability controller 170A for observation data stored in non-persistent storage 190A when needed (e.g., because a problem or anomaly was detected). Local observability controller 170A may provide observation data stored in the non-persistent storage 190A to the central observability controller 120 upon receiving such a request from the central observability controller 120.

In an embodiment, as new observation data is collected, local observability controller 170A overwrites/replaces older observation data stored in non-persistent storage 190A with the new observation data (e.g., the oldest observation data stored in non-persistent storage 190A gets overwritten/replaced first). The approach described above may help reduce network usage (e.g., since local observability controller 170A only sends some of the collected observation data to the central observability controller 120) and may help reduce memory usage (e.g., since older observation data is overwritten/replaced by newer observation data in a “dash cam” like manner). Also, the approach described above allows the central observability controller 120 to “time shift” the observation data (e.g., access older observation data) when needed.

In an embodiment, local observability controller 170A changes the detail level of observation data collected by exporter 180A without receiving an instruction from the central observability controller 120 to do so. That is, local observability controller 170A may independently determine to change the detail level of observation data collected by exporter 180A. For example, local observability controller 170A may independently change the detail level of observation data collected by exporter 180A based on detecting an increase or decrease in network traffic, a change in latency, a change in queue size, a change in a resend counter, a change in the number of rejected connection requests, a change in CPU utilization/load, a change in memory usage, or the like.

Thus, the detail level of observation data collected by the observability system may be adjusted over time based on decisions made by the controller computing node 110 (a “dynamic” approach) and/or by decisions made by individual agent computing nodes 150 (an “adaptive” approach).

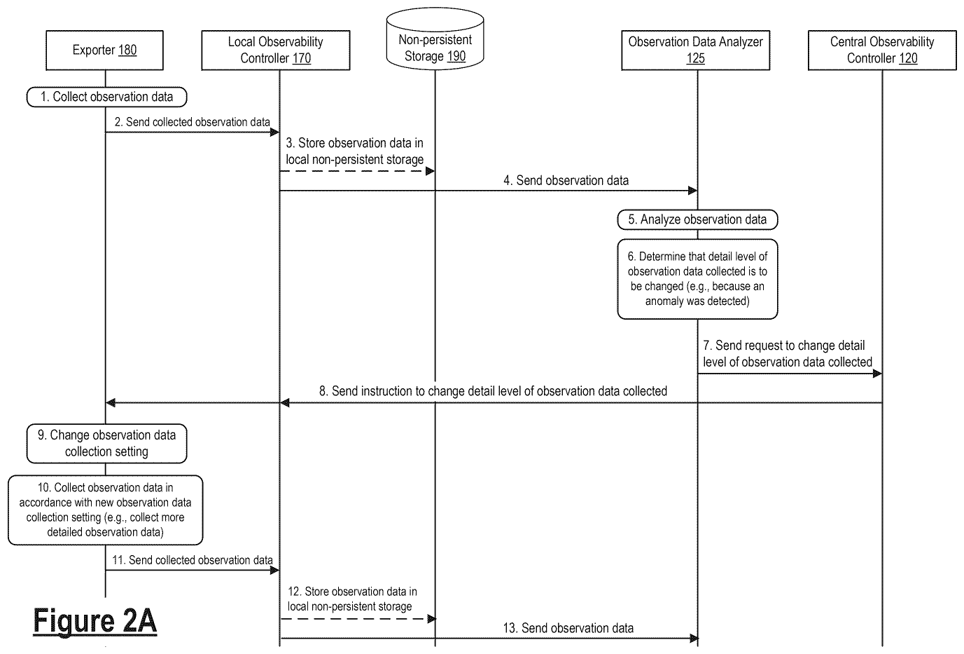

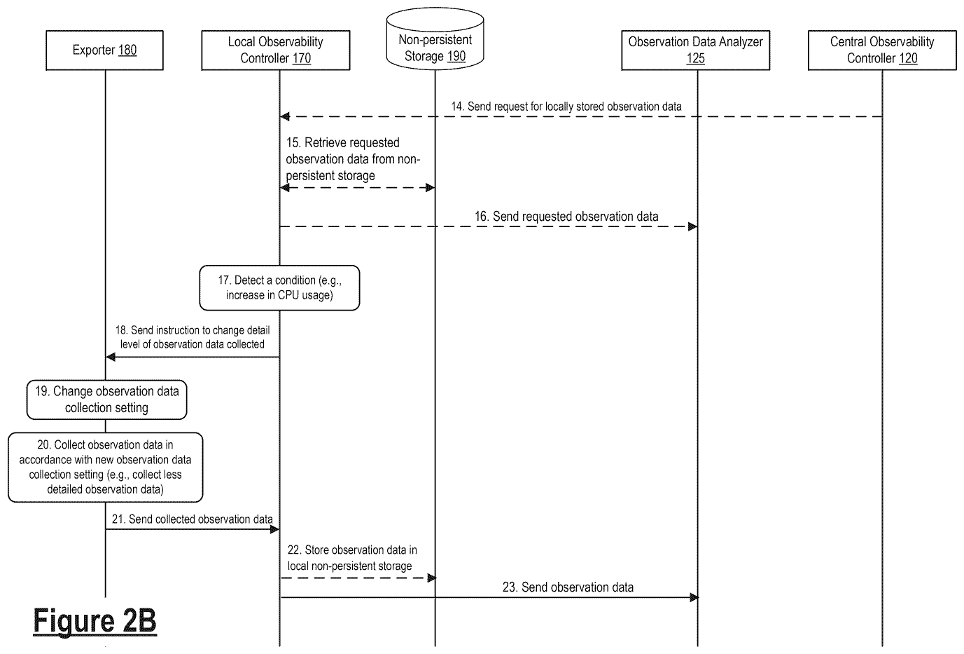

FIG. 2A is a diagram showing interactions between components to dynamically adjust the detail level of observation data collected by an observability system, according to some embodiments.

At operation 1, the exporter 180 of an agent computing node 150 collects observation data. At operation 2, the exporter 180 sends the collected observation data to the local observability controller 170. In an embodiment, at operation 3, the local observability controller 170 stores observation data (e.g., a subset of the observation data collected by the exporter 180) in a local non-persistent storage 190. At operation 4, the local observability controller 170 sends observation data (e.g., the observation data collected by the exporter 180 that was not stored in the local non-persistent storage 190) to the observation data analyzer 125 of a controller computing node 110 (e.g., via the central observability controller 120). The local observability controller 170 may decide which observation data to send to the observation data analyzer 125 and which observation data to withhold from sending to the observation data analyzer 125 (and to store in the local non-persistent storage 190) (e.g., based on current conditions and/or based on receiving instructions from the central observability controller 120). In an embodiment, the local observability controller 170 sends observation data to the observation data analyzer 125 using an observability API/framework such as OpenTelemetry (using a “push” or “pull” mechanism). At operation 5, the observation data analyzer 125 analyzes the observation data (e.g., to detect problems or anomalies). At operation 6, the observation data analyzer 125 determines, based on the analysis, that the detail level of observation data collected is to be changed. For example, the observation data analyzer 125 may determine that more detailed observation data is to be collected because an anomaly was detected. At operation 7, the observation data analyzer 125 sends a request to the central observability controller 120 to change the detail level of observation data collected. At operation 8, the central observability controller 120 sends an instruction to the exporter 180 (e.g., via the local observability controller 170) (and possibly one or more other exporters 180) to change the detail level of observation data that the exporter 180 collects. For example, if an anomaly was detected, then the central observability 120 may send an instruction to the exporter 180 to collect more detailed observation data than before. At operation 9, the exporter 180 changes its observation data collection setting in accordance with the instruction. At operation 10, the exporter 180 collects observation data in accordance with the new observation data collection setting. At operation 11, the exporter 180 sends the collected observation data to the local observability controller 170. In an embodiment, at operation 12, similar to operation 3 described above, the local observability controller 170 stores observation data in a local non-persistent storage 190. At operation 13, similar to operation 4 described above, the local observability controller 170 sends observation data to the observation data analyzer 125 (e.g., via the central observability controller 120). Operations 5 to 13 may be repeated to dynamically adjust the detail level of observation data collected by the observability system over time. Operations 1-13 are example operations for implementing a dynamic approach, where the controller computing node 110 determines when the detail level of observation data collected is to be changed and instructs the agent computing node(s) 150 to change the detail level of observation data they collect.

FIG. 2B is a diagram showing interactions between components to retrieve locally stored observation data and adaptively adjust the detail level of observation data collected by an observability system, according to some embodiments.

As shown in the diagram, in an embodiment, at operation 14, the central observability controller 120 sends a request to the local observability controller 170 for locally stored observation data (e.g., which the central observability controller 120 did not previously receive because the local observability controller 170 decided not to send that data to the central observability controller 120 and instead store the data in the local non-persistent storage 190). At operation 15, the local observability controller 170 retrieves the requested observation data from the local non-persistent storage 190. At operation 16, the local observability controller 170 sends the requested observation data to the observation data analyzer 125 (e.g., via the central observability controller 120). Operations 14-16 are example operations for implementing “time shifting,” where the controller computing node 110 can access older observation data collected and stored by agent computing nodes 150 when needed.

As shown in the diagram, at operation 17, the local observability controller 170 detects a condition that triggers a change in the detail level of observation data collected. For example, the local observability controller 170 may detect an increase in CPU usage and determine that less detailed observation data is to be collected to reduce the CPU usage. At operation 18, the local observability controller 170 sends an instruction to the exporter 180 to change the detail level of observation data collected by the exporter 180. At operation 19, the exporter 180 changes its observation data collection setting in accordance with the instruction. At operation 20, the exporter 180 collects observation data in accordance with the new observation data collection setting. At operation 21, the exporter 180 sends the collected observation data to the local observability controller 170. In an embodiment, at operation 22, similar to operation 3 described above, the local observability controller 170 stores observation data in a local non-persistent storage 190. At operation 23, similar to operation 4 described above, the local observability controller 170 sends observation data to the observation data analyzer 125 (e.g., via the central observability controller 120). Operations 17-23 are example operations for implementing an adaptive approach, where an agent computing node 150 can independently (without receiving explicit instructions from the controller computing node 110) change the detail level of observation data that it collects.

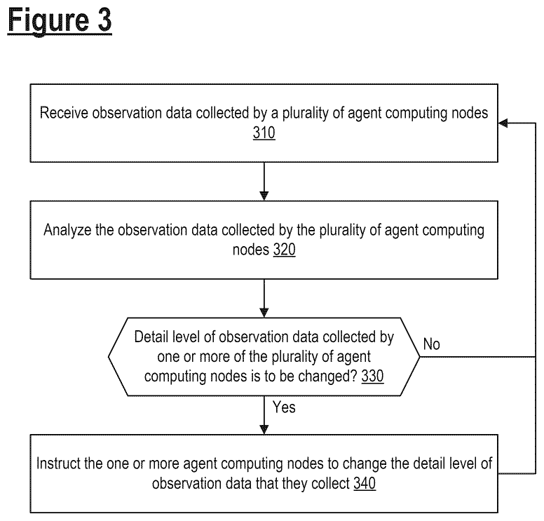

FIG. 3 is a flow diagram showing a method performed by a controller computing node for dynamically adjusting the detail level of observation data collected by an observability system, according to some embodiments. The method may be implemented in hardware, software, or a combination thereof.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

At operation 310, the controller computing node receives observation data collected by a plurality of agent computing nodes. In an embodiment, the observation data collected by the plurality of computing nodes includes measurement data and/or trace data.

At operation 320, the controller computing node analyzes the observation data collected by the plurality of agent computing nodes. In an embodiment, the observation data collected by the plurality of computing nodes is analyzed using a rule-based algorithm or a machine leaning algorithm.

At operation 330, the controller computing node determines whether the detail level of observation data collected by one or more of the plurality of agent computing nodes is to be changed. If not, the method returns to operation 310. Otherwise, if the controller computing node determines that the detail level of observation data collected by one or more of the plurality of agent computing nodes is to be changed, then at operation 340, the controller computing node instructs the one or more agent computing nodes to change the detail level of observation data that they collect. The method may then return to operation 310 to repeat operations 310-340. In an embodiment, the one or more agent computing nodes are those of the plurality of agent computing nodes that have been determined to be associated with an anomaly that was detected based on analyzing the observation data collected by the plurality of agent computing nodes. In an embodiment, instructing the one or more agent computing nodes to change the detail level of observation data that they collect causes the one or more computing nodes to collect more (or less) detailed observation data than before. As used herein, a change in detail level of observation data collected may refer to a change in the amount of observation data collected, the frequency of observation data collected, and/or the type of observation data collected.

In an embodiment, the controller computing node sends, to an agent computing node from the plurality of agent computing nodes, a request for observation data collected by the agent computing node that is temporarily stored in a non-persistent storage of the agent computing node and was not sent by the agent computing node to the controller computing node.

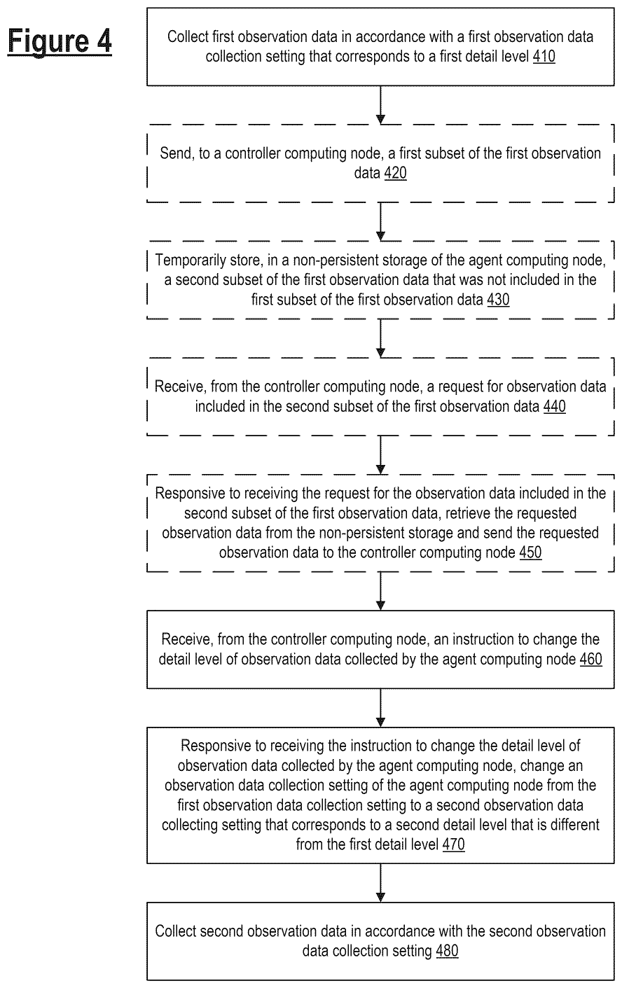

FIG. 4 is a flow diagram showing a method performed by an agent computing node for dynamically adjusting the detail level of observation data collected by an observability system, according to some embodiments. The method may be implemented in hardware, software, or a combination thereof.

At operation 410, the agent computing node collects first observation data in accordance with a first observation data collection setting that corresponds to a first detail level.

In an embodiment, at operation 420, the agent computing node sends, to a controller computing node, a first subset of the first observation data. At operation 430, the agent computing node temporarily stores, in a non-persistent storage of the agent computing node, a second subset of the first observation data that was not included in the first subset of the first observation data.

In an embodiment, at operation 440, the agent computing node receives, from the controller computing node, a request for observation data included in the second subset of the first observation data. At operation 450, responsive to receiving the request for the observation data included in the second subset of the first observation data, the agent computing node retrieves the requested observation data from the non-persistent storage and sends the requested observation data to the controller computing node. In an embodiment, the agent computing node overwrites, in the non-persistent storage, the second subset of the first observation data with new observation data collected by the agent computing node after the first observation data was collected.

At operation 460, the agent computing node receives, from the controller computing node, an instruction to change the detail level of observation data collected by the agent computing node.

At operation 470, responsive to receiving the instruction to change the detail level of observation data collected by the agent computing node, the agent computing node changes an observation data collection setting of the agent computing node from the first observation data collection setting to a second observation data collecting setting that corresponds to a second detail level that is different from the first detail level.

At operation 480, the agent computing node collects second observation data in accordance with the second observation data collection setting.

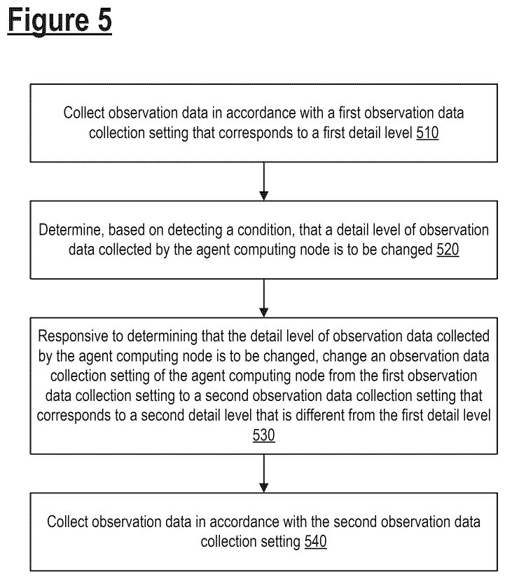

FIG. 5 is a flow diagram showing operations performed by an agent computing node for adaptively adjusting the detail level of observation data collected by an observability system, according to some embodiments. The method may be implemented in hardware, software, or a combination thereof. In an embodiment, the agent computing node performs the operations shown in FIG. 5 in addition to one or more of the operations shown in FIG. 4.

At operation 510, the agent computing node collects observation data in accordance with a first observation data collection setting that corresponds to a first detail level.

At operation 520, the agent computing node determines, based on detecting a condition, that a detail level of observation data collected by the agent computing node is to be changed (without receiving an instruction from a controller computing node). In an embodiment, the condition includes one or more of: an existence of an anomaly in an operation of the agent computing node, a change in an operational status of the agent computing node, and a change in an amount of resources used by the agent computing node.

At operation 530, responsive to determining that the detail level of observation data collected by the agent computing node is to be changed, the agent computing node changes an observation data collection setting of the agent computing node from the first observation data collection setting to a second observation data collection setting that corresponds to a second detail level that is different from the first detail level.

At operation 540, the agent computing node collects observation data in accordance with the second observation data collection setting.

While embodiments have been primarily described in the context of an observability system, it should be understood that embodiments are not so limited. Embodiments may be used and/or adapted to other contexts. For example, embodiments may be adapted to a firewall system context. A controller computing node may manage multiple web application firewalls (WAFs). The controller computing node may determine that the security rules used by the WAFs should be updated (e.g., to more heavily scrutinize network traffic and/or block certain network traffic) if the controller computing node detects there is suspicious network traffic in the network. Responsive to such determination, the controller computing node may send instructions to the relevant WAFs to update their security rules. The controller computing node may determine the security rules that the WAFs should use, for example, based on the invalid, unauthorized, and/or unrecognized requests seen in the network traffic. Additionally or alternatively, individual WAFs may also decide to update their security rules without involvement of the controller computing node.

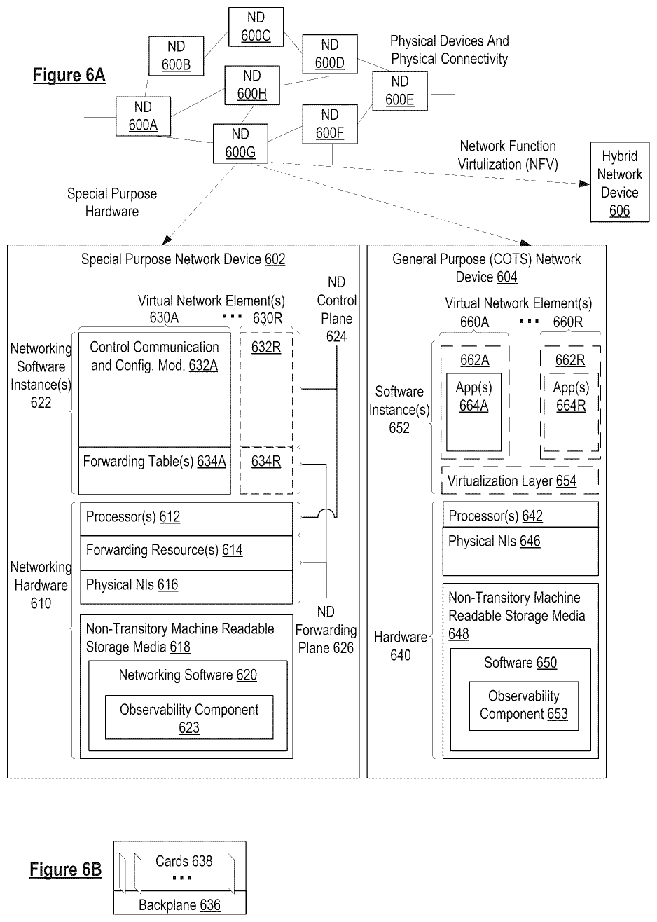

FIG. 6A illustrates connectivity between network devices (NDs) within an exemplary network, as well as three exemplary implementations of the NDs, according to some embodiments of the invention. FIG. 6A shows NDs 600A-H, and their connectivity by way of lines between 600A-600B, 600B-600C, 600C-600D, 600D-600E, 600E-600F, 600F-600G, and 600A-600G, as well as between 600H and each of 600A, 600C, 600D, and 600G. These NDs are physical devices, and the connectivity between these NDs can be wireless or wired (often referred to as a link). An additional line extending from NDs 600A, 600E, and 600F illustrates that these NDs act as ingress and egress points for the network (and thus, these NDs are sometimes referred to as edge NDs; while the other NDs may be called core NDs).

Two of the exemplary ND implementations in FIG. 6A are: 1) a special-purpose network device 602 that uses custom application-specific integrated-circuits (ASICs) and a special-purpose operating system (OS); and 2) a general purpose network device 604 that uses common off-the-shelf (COTS) processors and a standard OS.

The special-purpose network device 602 includes networking hardware 610 comprising a set of one or more processor(s) 612, forwarding resource(s) 614 (which typically include one or more ASICs and/or network processors), and physical network interfaces (NIs) 616 (through which network connections are made, such as those shown by the connectivity between NDs 600A-H), as well as non-transitory machine readable storage media 618 having stored therein networking software 620. During operation, the networking software 620 may be executed by the networking hardware 610 to instantiate a set of one or more networking software instance(s) 622. Each of the networking software instance(s) 622, and that part of the networking hardware 610 that executes that network software instance (be it hardware dedicated to that networking software instance and/or time slices of hardware temporally shared by that networking software instance with others of the networking software instance(s) 622), form a separate virtual network element 630A-R. Each of the virtual network element(s) (VNEs) 630A-R includes a control communication and configuration module 632A-R (sometimes referred to as a local control module or control communication module) and forwarding table(s) 634A-R, such that a given virtual network element (e.g., 630A) includes the control communication and configuration module (e.g., 632A), a set of one or more forwarding table(s) (e.g., 634A), and that portion of the networking hardware 610 that executes the virtual network element (e.g., 630A).

In an embodiment software 620 includes code such as observability component 623, which when executed by networking hardware 610, causes the special-purpose network device 602 to perform operations of one or more embodiments disclosed herein as part of networking software instances 622 (e.g., to dynamically and/or adaptively adjust the detail level of observation data collected by an observability system).

The special-purpose network device 602 is often physically and/or logically considered to include: 1) a ND control plane 624 (sometimes referred to as a control plane) comprising the processor(s) 612 that execute the control communication and configuration module(s) 632A-R; and 2) a ND forwarding plane 626 (sometimes referred to as a forwarding plane, a data plane, or a media plane) comprising the forwarding resource(s) 614 that utilize the forwarding table(s) 634A-R and the physical NIs 616. By way of example, where the ND is a router (or is implementing routing functionality), the ND control plane 624 (the processor(s) 612 executing the control communication and configuration module(s) 632A-R) is typically responsible for participating in controlling how data (e.g., packets) is to be routed (e.g., the next hop for the data and the outgoing physical NI for that data) and storing that routing information in the forwarding table(s) 634A-R, and the ND forwarding plane 626 is responsible for receiving that data on the physical NIs 616 and forwarding that data out the appropriate ones of the physical NIs 616 based on the forwarding table(s) 634A-R.

FIG. 6B illustrates an exemplary way to implement the special-purpose network device 602 according to some embodiments of the invention. FIG. 6B shows a special-purpose network device including cards 638 (typically hot pluggable). While in some embodiments the cards 638 are of two types (one or more that operate as the ND forwarding plane 626 (sometimes called line cards), and one or more that operate to implement the ND control plane 624 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 636 (e.g., a first full mesh coupling the line cards and a second full mesh coupling all of the cards).

Returning to FIG. 6A, the general purpose network device 604 includes hardware 640 comprising a set of one or more processor(s) 642 (which are often COTS processors) and physical NIs 646, as well as non-transitory machine readable storage media 648 having stored therein software 650. During operation, the processor(s) 642 execute the software 650 to instantiate one or more sets of one or more applications 664A-R. While one embodiment does not implement virtualization, alternative embodiments may use different forms of virtualization. For example, in one such alternative embodiment the virtualization layer 654 represents the kernel of an operating system (or a shim executing on a base operating system) that allows for the creation of multiple instances 662A-R called software containers that may each be used to execute one (or more) of the sets of applications 664A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 654 represents a hypervisor (sometimes referred to as a virtual machine monitor (VMM)) or a hypervisor executing on top of a host operating system, and each of the sets of applications 664A-R is run on top of a guest operating system within an instance 662A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 640, directly on a hypervisor (in which case the unikernel is sometimes described as running within a LibOS virtual machine), or in a software container, embodiments can be implemented fully with unikernels running directly on a hypervisor represented by virtualization layer 654, unikernels running within software containers represented by instances 662A-R, or as a combination of unikernels and the above-described techniques (e.g., unikernels and virtual machines both run directly on a hypervisor, unikernels and sets of applications that are run in different software containers).

The instantiation of the one or more sets of one or more applications 664A-R, as well as virtualization if implemented, are collectively referred to as software instance(s) 652. Each set of applications 664A-R, corresponding virtualization construct (e.g., instance 662A-R) if implemented, and that part of the hardware 640 that executes them (be it hardware dedicated to that execution and/or time slices of hardware temporally shared), forms a separate virtual network element(s) 660A-R.

The virtual network element(s) 660A-R perform similar functionality to the virtual network element(s) 630A-R—e.g., similar to the control communication and configuration module(s) 632A and forwarding table(s) 634A (this virtualization of the hardware 640 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 662A-R corresponding to one VNE 660A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 662A-R to VNEs also apply to embodiments where such a finer level of granularity and/or unikernels are used.

In certain embodiments, the virtualization layer 654 includes a virtual switch that provides similar forwarding services as a physical Ethernet switch. Specifically, this virtual switch forwards traffic between instances 662A-R and the physical NI(s) 646, as well as optionally between the instances 662A-R; in addition, this virtual switch may enforce network isolation between the VNEs 660A-R that by policy are not permitted to communicate with each other (e.g., by honoring virtual local area networks (VLANs)).

In an embodiment, software 650 includes an observability component 653, which when executed by processor(s) 642, causes the general purpose network device 604 to perform operations of one or more embodiments of disclosed herein as part of software instances 662A-R (e.g., to dynamically and/or adaptively adjust the detail level of observation data collected by an observability system).

The third exemplary ND implementation in FIG. 6A is a hybrid network device 606, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 602) could provide for para-virtualization to the networking hardware present in the hybrid network device 606.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 630A-R, VNEs 660A-R, and those in the hybrid network device 606) receives data on the physical NIs (e.g., 616, 646) and forwards that data out the appropriate ones of the physical NIs (e.g., 616, 646). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

In the foregoing specification, embodiments have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A method performed by a controller computing node to dynamically change a detail level of observation data collected by an observability system, the method comprising:
receiving observation data collected by a plurality of agent computing nodes;
determining, based on analyzing the observation data collected by the plurality of agent computing nodes, that a detail level of observation data collected by one or more of the plurality of agent computing nodes is to be changed; and
responsive to determining that the detail level of observation data collected by the one or more agent computing nodes is to be changed, instructing the one or more agent computing nodes to change the detail level of observation data that they collect.

2. The method of claim 1, wherein the one or more agent computing nodes are those of the plurality of agent computing nodes that have been determined to be associated with an anomaly that was detected based on analyzing the observation data collected by the plurality of agent computing nodes.

3. The method of claim 1, wherein the observation data collected by the plurality of computing nodes is analyzed using a rule-based algorithm or a machine leaning algorithm.

4. The method of claim 1, wherein the observation data collected by the plurality of computing nodes includes measurement data and trace data.

5. The method of claim 1, wherein instructing the one or more agent computing nodes to change the detail level of observation data that they collect causes the one or more computing nodes to collect more detailed observation data than before.

6. The method of claim 1, further comprising:
sending, to an agent computing node from the plurality of agent computing nodes, a request for observation data collected by the agent computing node that is temporarily stored in a non-persistent storage of the agent computing node and was not sent by the agent computing node to the controller computing node.

7. A method performed by an agent computing node to change a detail level of observation data collected by the agent computing node, the method comprising:
collecting first observation data in accordance with a first observation data collection setting that corresponds to a first detail level;
receiving, from a controller computing node, an instruction to change the detail level of observation data collected by the agent computing node;
responsive to receiving the instruction to change the detail level of observation data collected by the agent computing node, changing an observation data collection setting of the agent computing node from the first observation data collection setting to a second observation data collecting setting that corresponds to a second detail level that is different from the first detail level; and
collecting second observation data in accordance with the second observation data collection setting.

8. The method of claim 7, further comprising:
sending, to the controller computing node, a first subset of the first observation data; and
temporarily storing, in a non-persistent storage of the agent computing node, a second subset of the first observation data that was not included in the first subset of the first observation data.

9. The method of claim 8, further comprising:
receiving, from the controller computing node, a request for observation data included in the second subset of the first observation data; and
responsive to receiving the request for the observation data included in the second subset of the first observation data, retrieving the requested observation data from the non-persistent storage and sending the requested observation data to the controller computing node.

10. The method of claim 8, further comprising:
overwriting, in the non-persistent storage, the second subset of the first observation data with new observation data collected by the agent computing node after the first observation data was collected.

11. The method of claim 7, further comprising:
determining, based on detecting a condition, that the detail level of observation data collected by the agent computing node is to be changed;
responsive to determining that the detail level of observation data collected by the agent computing node is to be changed, changing the observation data collection setting of the agent computing node from the second observation data collection setting to a third observation data collection setting that corresponds to a third detail level that is different from the second detail level; and
collecting third observation data in accordance with the third observation data collection setting.

12. The method of claim 11, wherein the condition includes one or more of: an existence of an anomaly in an operation of the agent computing node, a change in an operational status of the agent computing node, and a change in an amount of resources used by the agent computing node.

13. A non-transitory machine-readable storage medium that provides instructions that, if executed by a processor of a computing device implementing a controller computing node, will cause the controller computing node to carry out a method comprising:
receiving observation data collected by a plurality of agent computing nodes;
determining, based on analyzing the observation data collected by the plurality of agent computing nodes, that a detail level of observation data collected by one or more of the plurality of agent computing nodes is to be changed; and
responsive to determining that the detail level of observation data collected by the one or more agent computing nodes is to be changed, instructing the one or more agent computing nodes to change the detail level of observation data that they collect.

14. (canceled)

15. The non-transitory machine-readable storage medium of claim 13, wherein the one or more agent computing nodes are those of the plurality of agent computing nodes that have been determined to be associated with an anomaly that was detected based on analyzing the observation data collected by the plurality of agent computing nodes.

16. The non-transitory machine-readable storage medium of claim 13, wherein the observation data collected by the plurality of computing nodes is analyzed using a rule-based algorithm or a machine leaning algorithm.

17. The non-transitory machine-readable storage medium of claim 13, wherein the observation data collected by the plurality of computing nodes includes measurement data and trace data.

18. The non-transitory machine-readable storage medium of claim 13, wherein instructing the one or more agent computing nodes to change the detail level of observation data that they collect causes the one or more computing nodes to collect more detailed observation data than before.

19. The non-transitory machine-readable storage medium of claim 13, wherein the method further comprises sending, to an agent computing node from the plurality of agent computing nodes, a request for observation data collected by the agent computing node that is temporarily stored in a non-persistent storage of the agent computing node and was not sent by the agent computing node to the controller computing node.

20. A controller computing node of a network, the controller computing node comprising:
processing circuitry;
memory coupled with the processing circuitry, wherein the memory includes instructions that, when executed by the processing circuitry, causes the controller computing node to perform operations comprising:
receiving observation data collected by a plurality of agent computing nodes;
determining, based on analyzing the observation data collected by the plurality of agent computing nodes, that a detail level of observation data collected by one or more of the plurality of agent computing nodes is to be changed; and
responsive to determining that the detail level of observation data collected by the one or more agent computing nodes is to be changed, instructing the one or more agent computing nodes to change the detail level of observation data that they collect.
